(19) United States
(12) Patent Application Publication
(10) Pub. No.: US 2017/0300560 A1
(43) Pub. Date: Oct. 19, 2017

(54) CONTEXT MODIFICATION OF QUERIES

(71) Applicant: eBay Inc., San Jose, CA (US)

(72) Inventor: Tyler Yong Nugent, Portland, OR (US)

(21) Appl. No.: 15/131,943

(22) Filed: Apr. 18, 2016

(51) Int. Cl. G06F 17/30; G06F 3/0488; G06F 3/0484

(52) U.S. Cl. CPC G06F 17/30646; G06F 17/30528; G06F 3/04842; G06F 3/04847; G06F 3/04883

(57) ABSTRACT

Disclosed are systems and methods for context modification of queries to refine search results. A user may make a force-interval selection of one or more display elements displayed on the screen of a mobile computing device. The selected display elements may be analyzed to determine context. One or more context options may be displayed onscreen for user selection. A selected context option can cause the mobile computing device to modify the original query to generate a context-modified query. The context-modified query can be used to retrieve refined search results.

### TECHNICAL FIELD

The present application relates generally to the technical field of computer databases and, in various embodiments, to systems and methods of modifying database queries using context.

### BACKGROUND

Users are increasingly using their mobile computing devices, such as smart phones, to access search sites (e.g., search engines) to search for content or items. In the past, these searches or queries were conducted on full-desktop computing systems that typically have a full-size computer display monitor and full-size physical or mechanical input/output (I/O) interfaces, such as a keyboard and mouse.

In contrast, mobile computing devices may use a touch-screen as their primary I/O interface. Searching for content or items on a mobile computing system through a touch-screen has numerous limitations. For example, touch-screens on mobile computing systems typically have limited screen sizes. Refining queries on mobile computing devices that have limited screen size can be a time consuming process. A user wanting to modify and refine a search string may have to delve into several onscreen menus to search for refinement options. As mobile computing devices have limited screen size, viewing the menus may be overly complex and force a user to open multiple sub-menus, which may spontaneously collapse as a menu tree is being searched. Further, the menus onscreen typically obfuscate the underlying results, thus further hampering the search process. Further, a user may be required to continually change a search string through a mobile keyboard, which adds additional time to type each refinement term. Finally, many past approaches require the user to navigate or type on a mobile computing device using two hands, which can be cumbersome and less usable; sometimes two-hand navigation may not be an option for the user, for example, when the user has only one hand free to operate the mobile computing device.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a network diagram depicting a client-server system, within which one example embodiment may be deployed.

FIGS. 2A and 2B shows an interaction diagram depicting example exchanges between a client device and an application server, according to example embodiments.

FIG. 3 illustrates a block diagram showing components provided within a networked system, as according to some embodiments.

FIG. 4 shows a flowchart illustrating a method for processing context modified queries, as according to some embodiments.

FIGS. 5A-5C show example user interfaces on a contact display, as according to some embodiments.

FIG. 6 shows an example user interface on a contact display, as according to some embodiments.

FIG. 7 shows a diagrammatic representation of a machine in the example form of a computer system within which a set of instructions may be executed to cause the machine to perform any one or more of the methodologies discussed herein, in accordance with some embodiments.

### DETAILED DESCRIPTION

Reference will now be made in detail to specific example embodiments for carrying out the inventive subject matter. Examples of these specific embodiments are illustrated in the accompanying drawings. It will be understood that these examples are not intended to limit the scope of the claims to the illustrated embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details.

Aspects of the present disclosure involve a context modification of database queries through a contact display, such as a touch-enabled display screen. Generally, a contact display is a display screen that is operable to display a user interface, wherein a user can select items within the user interface by directly depressing over the desired area.

Example embodiments include systems and methods for receiving a search string through a contact display (e.g., a touch-screen display of a mobile device) of a client device. The client device may convey the search string to a server, which queries one or more databases to retrieve search string results, which are then transmitted back to the client device for display. A user of the client device may view the search string results and select a display element of the search string results through the contact display. The selection may be performed using a selection gesture or force-interval selection action, which may be a long-press (e.g., press-and-hold for an interval of time) click action, a pressure based click action (e.g., firmly pressing on an item for an interval of time to select it as opposed to a light tap to select), or a sequenced pressure click action (e.g., tap on item, followed by firm press on the item).

The client device may detect that a display element has been selected using a force-interval selection action and analyze the selected display element to determine the context of the element. The context of the element may pertain to whether the underlying content of the element is filter-related (e.g., a “Free Shipping” icon selected) or keyword-related (e.g., selected “red” in results for a smart-phone case). Further, in some embodiments, the context of the element may correspond to the location of the display element in the contact display, tags, or other contexts, as discussed in further detail below.

The client device may then display one or more context options based on the identified context of the display element. Example context options can include appending a selected keyword to a search string and creating a filter based on a selected display element. A user may use the contact display to select a contact option. The client device may then modify the original search string based on the selected context option. In some embodiments, the selected word is appended to the end of the search string and stored as a modified search string. In some embodiments, filter metadata related to the search string is generated and stored with the original search string as a modified search string. The modified search string may then be sent to the server, which may provide modified search string results to the client device for display. The user can again force-interval select elements onscreen to further refine the search process. In this way, a user can quickly refine search results in systems where screen size is limited, as occurs in cell phones; further, the user can modify search results with one hand and/or one digit (e.g., thumb), without bringing up a full keyboard or search menus.

To this end, the disclosed approach may perform a method for modifying application queries by displaying initial query results for an initial query received from a contact display interface; receiving, via the contact display interface, a force-interval selection of a display element of the initial query results; determining the context of the display element; modifying the initial query based at least in part on the context of the display element to generate a modified query; and/or receiving modified query results for display on the contact display interface.

Further, in some embodiments, such a computer-implemented method may further include displaying one or more options for modifying the initial query based on the context and/or receiving selection of the one or more options through the contact display interface. Further, in some embodiments, the initial query results can be modified based on the selection. Further, in some embodiments, the context can be determined based on keywords in the selected display element. Further, in some embodiments, the context can be determined based on the location of the selected display element within the contact display interface. Further, in some embodiments, the context can be determined based on a class attribute of the selected display element. Further, in some embodiments, the force-interval selection can be a selection action based on an amount of time in contact with the contact display interface when selecting the display element. Further, in some embodiments, the force-interval selection can be a selection action based on an amount of pressure applied to the contact display interface when selecting the display element. Further, in some embodiments, the contact display interface can be a touch-screen display of a mobile device. Further, in some embodiments, the initial query results and modified query results are received from a server over a network, such as the Internet.

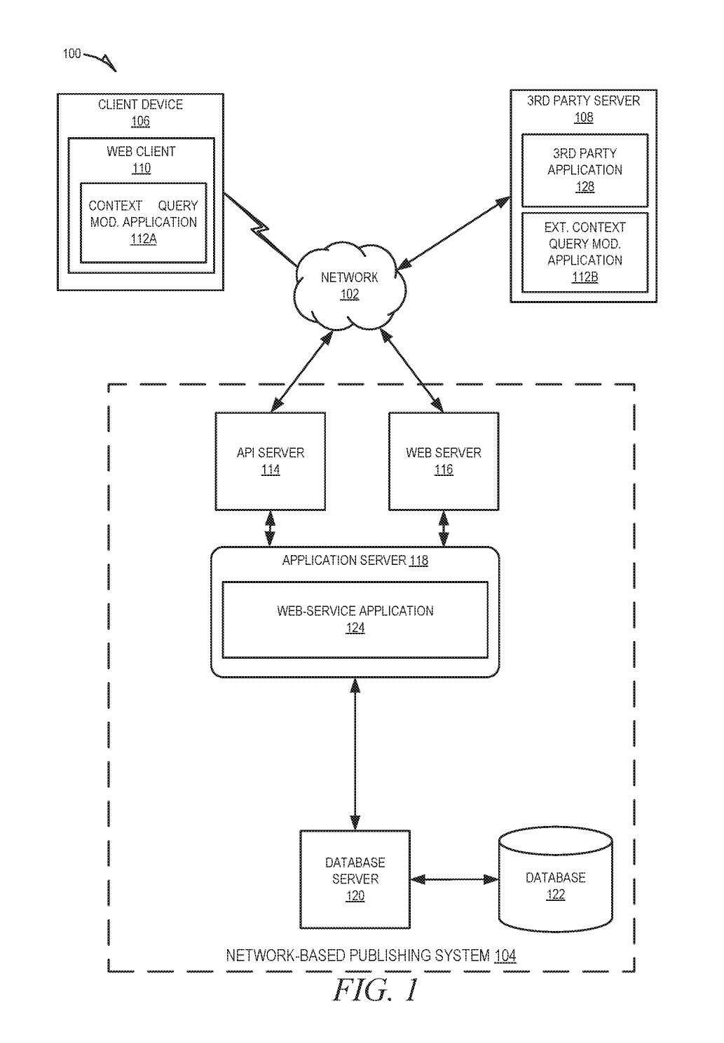

FIG. 1 is a network diagram depicting a network system 100, according to one embodiment, having a client-server architecture configured for exchanging data over a network 102 (e.g., the Internet). While the network system 100 is depicted as having a client-server architecture, the present inventive subject matter is, of course, not limited to such an architecture, and could equally well find application in an event-driven, distributed, or peer-to-peer architecture system, for example. Further, to avoid obscuring the inventive subject matter with unnecessary detail, various functional components that are not germane to conveying an understanding of the inventive subject matter have been omitted from FIG. 1. Moreover, it shall be appreciated that although the various functional components of the network system 100 are discussed in a singular sense, multiple instances of any one of the various functional components may be employed.

The network system 100 includes a network-based publishing system 104 in communication with a client device 106 and a third party server 108 over the network 102. In some example embodiments, the network-based publishing system 104 may be a content publishing service for publication of items (e.g., eBay.com). The network-based publishing system 104 communicates and exchanges data within the network system 100 that may pertain to various functions and aspects associated with the network system 100 and its users. The network-based publishing system 104 may provide server-side functionality, via the network 102, to network devices such as the client device 106.

The client device 106 may be operated by users who use the network system 100 to exchange data over the network 102. These data exchanges may include transmitting, receiving (communicating), and processing data to, from, and regarding content and users of the network system 100. The data may include, but are not limited to, search strings (e.g., queries); images; video or audio content; user preferences; product and service feedback, advice, and reviews; product, service, manufacturer, and vendor recommendations and identifiers; product and service listings associated with buyers and sellers; product and service advertisements; auction bids; transaction data; user profile data; and social data, among other things.

In various embodiments, the data exchanged within the network system 100 may be dependent upon user-selected functions available through one or more client or user interfaces (UIs). The UIs may be associated with a web client 110 (e.g., an Internet browser, a network-based publishing system search application) operating on the client device 106, which may be in communication with the network-based publishing system 104. The UIs may also be associated with one or more applications executing on the client device 106, such as a mobile application designed for efficiently interacting with the network-based publishing system 104. For example, the client device 106 may execute a context query modification application 112A that facilities detecting selection of one or more display elements of context displayed on the client device 106. The context query modification application 112A may further facilitate analyzing selected elements for context and modifying a query for submission to the network-based publishing system 104. As illustrated in FIG. 1, in some embodiments, the context query modification application 112A maybe integrated into the web client 110; further in some embodiments, the context query modification application 112A may be a module external to the client/application, as external context query modification application 112B illustrates.

Turning specifically to the network-based publishing system 104, an API server 114 and a web server 116 are coupled to, and provide programmatic and web interfaces respectively to, an application server 118. As illustrated in FIG. 1, the application server 118 is coupled via the API server 114 and the web server 116 to the network 102, for example, via wired or wireless interfaces. The application server 118 is, in turn, shown to be coupled to a database server 120 that facilitates access to a database 122 to retrieve query results. In some examples, the application server 118 can access the database 122 directly without the need for the database server 120. The database 122 may include multiple databases that may be internal or external to the network-based publishing system 104.

The application server 118 may, for example, host one or more applications, which may provide a number of content publishing and viewing functions and services to users who access the network-based publishing system 104. For example, the network-based publishing system 104 may host a web-service application 124 that provides a number of publishing system functions and services to users, such as image processing, publishing, listing, and price-setting mechanisms whereby the web-service application 124 may list (or publish information concerning) items for sale, a buyer can express interest in or indicate a desire to purchase the items, and a price can be set for a transaction pertaining to one or more of the items. Further, in some embodiments, such as those where the client device 106 has limited computing resources, one or more processing activities of the context query modification application 112A may be transmitted to the web-service application 124 for remote processing. For example, client device 106 may have sufficient processor strength and memory to do a rudimentary or limited analysis of the context of selected display elements; however, the client device 106 may transmit which display elements were selected to the web-service application 124 for more in-depth analysis of context and subsequent generation of context query modification options.

The database 122 includes a data repository of search results, such as item data including images (e.g., data files representing images), price, description data, processing data (e.g., shipping information, seller rating) of the items to be sold using the web-service application 124. The database 122 may also be used to store data pertaining to various functions and aspects associated with the network system 100 and its users. For example, the database 122 may store and maintain user profiles for users of the network-based publishing system 104. Each user profile may comprise user profile data that describes aspects of a particular user. The user profile data may, for example, include demographic data (e.g., gender, age, location information, employment history, education history, contact information, familial relations, or user interests), user preferences, social data, and financial information (e.g., an account number, a credential, a password, a device identifier, a user name, a phone number, credit card information, bank information, a transaction history, or other financial information which may be used to facilitate online transactions by the user).

FIG. 1 also illustrates a third party application 128 executing on the third party server 108 that may offer information or services to the application server 118 or to users of the client device 106. The third party application 128 may have programmatic access to the network-based publishing system 104 via a programmatic interface provided by the API server 114. The third party application 128 may be associated with any organization that conducts transactions with or provides services to the application server 118 or to users of the client device 106. As illustrated, the third party server 128 may also execute an external context query modification application 112B, which can run alongside the third party application 128. The third party application 128 can interface with the external context query modification application 112B to handle context analysis of selected inputs. As mentioned, context query modification applications 112A-B may be integrated into their respective platforms or applications, run externally, and further may use the web-service application 124 for enriched remote processing of various activities performed (e.g., enhanced cloud supported context analysis of selected elements).

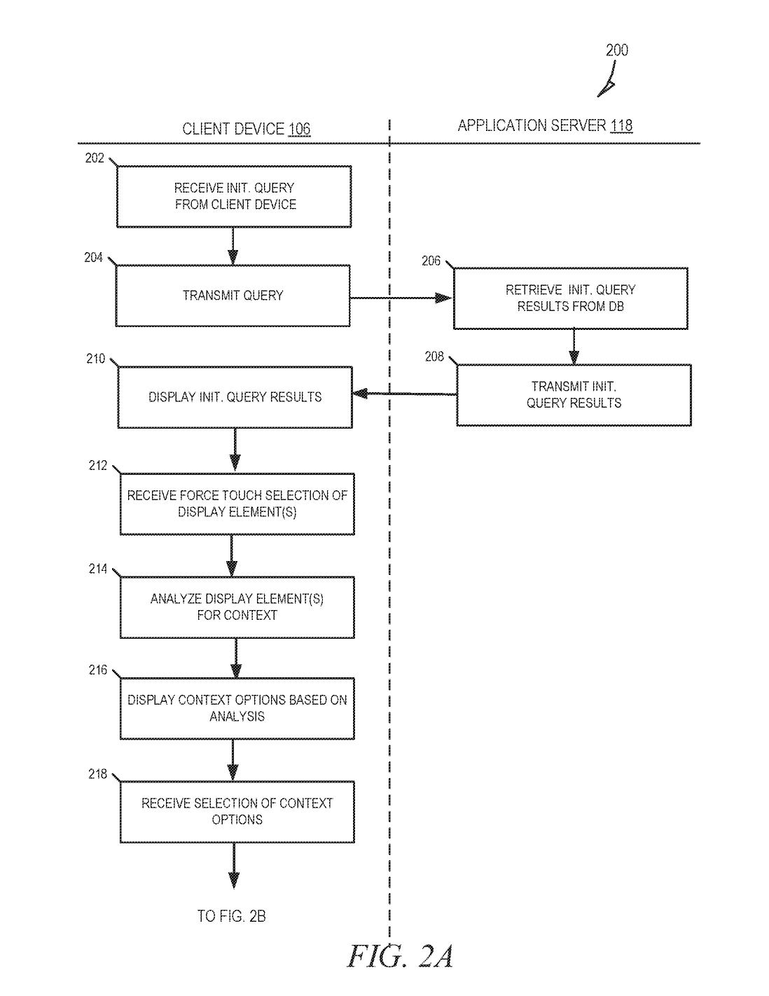

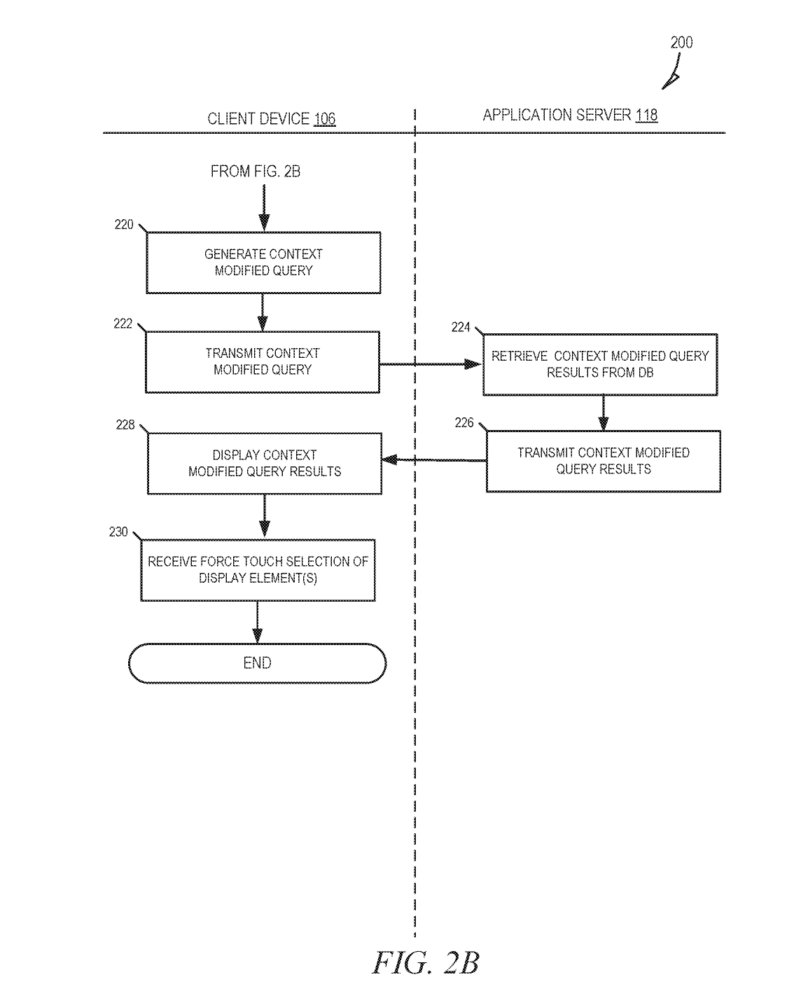

FIGS. 2A-B show an interaction diagram 200 depicting example exchanges between the client device 106 and the application server 118, according to example embodiments. The client device 106 may have a wireless transceiver (e.g., WiFi antenna; cellular 4G, LTE antenna(s)) that can connect to the network-based publishing system 104 through a network, such as the Internet. As shown, the process begins at operation 202, where the client device 106 may receive an initial query (e.g., search string) from an input interface of the client device 106. At operation 204, the client device 106 transmits the initial query to the application server 118. The application server 118 receives the initial query over one or more networks, and at operation 206 retrieves initial query results from one or more databases, such as database 122 (of FIG. 1). At operation 208, application server 118 transmits the initial query results to the client device 106, over one or more networks.

After the client device 106 receives the initial query results, the client device 106 displays the initial query results on a contact interface of the client device 106, as shown at operation 210. The user may view the initial query results and, at operation 212, select one or more display elements of the initial query results using a selection action such as a force-interval selection on the contact display. For example, if the initial query is “XBOX”, the initial query results may be a list of XBOX consoles and XBOX accessories (e.g., games, controllers, stickers, guidebooks, power cords); after viewing the list, the user may select the word “console” from a description of one of the listed items by pressing and holding his/her finger over the word “console” in the description.

At operation 214, the selected display element is analyzed to determine the context of the one or more display elements. For example, if the word “XBOX” is selected from the description, the client device 106 may identify the display element context as descriptive text or keywords related to a search string. At operation 216, the client device 106 may display one or more context options based on the analysis identifying the context to refine the initial query. For example, if “console” is selected, the client device 106 may identify the display element as a keyword and generate context options such as “append console” to search string or “remove console” from search results.

At operation 218, the client device 106 may receive a selection, via the contact interface, of one of the context options. Referring to FIG. 2B, at operation 220, the client device 106 generates a context modified query based on the selected context option. For example, if “append console” is selected, then “X BOX console” may be generated as the context modified query. Further, in some embodiments, the term “console” may be appended and weightings may be applied to deprioritize any search result that does not have “console” in the description or item page.

At operation 222, the client device 106 transmits the context modified query to the application server 118. At operation 224, the application server 118 retrieves the context modified query results from the one or more databases, such as database 122. Before retrieving the modified query results, the application server 118 may further parse the context modified query to correctly perform the modified query. For example, if one of the context options presented to the user at operation 216 is a “free shipping” parameter, a metadata parameter requiring that only that the field “shipping” be “free” can be set as a search parameter at operation 224 so that only results having “free shipping” are returned.

At operation 226, the application server 118 transmits the context modified query results to the client device 106. At operation 228, the client device 106 receives the context modified query results and displays them on the contact interface of the client device 106. At operation 230, the client device 106 receives a force-interval selection of one or more display elements to further refine the search. Operation 230 is similar to operation 218, but for newer context modified query results in operation 230. For example, if the context modified query results now include only XBOX consoles, the user may further select “one” to create a new search that returns results only showing results for the XBOX One. The process may iterate from operation 218 to operation 230 a number of times to further refine the search results with context analysis occurring in response to a context selection in each iteration.

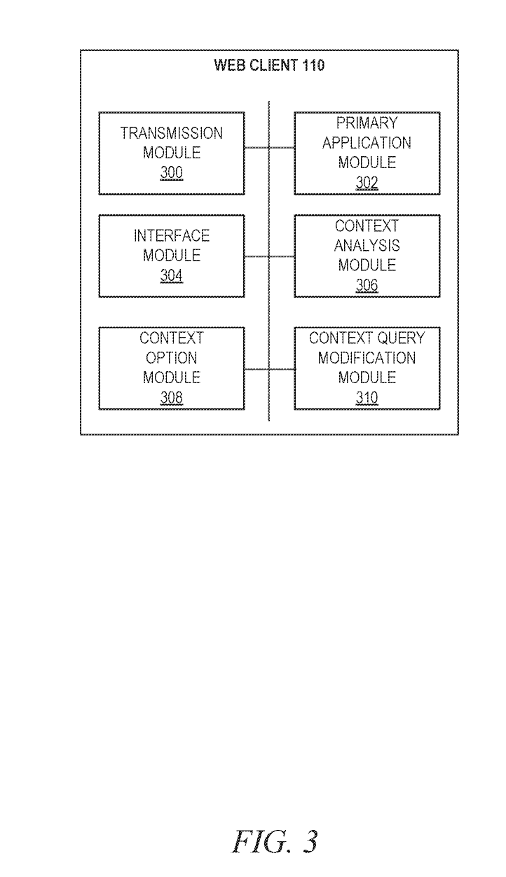

FIG. 3 is a block diagram depicting various functional components of web client 110, which is provided as part of the network system 100, according to example embodiments. As is understood by skilled artisans in the relevant computer and Internet-related arts, web client may correspond to a client side web application that interfaces with application server 118 or web-service application 124. Further, the components As is understood by skilled artisans in the relevant computer and Internet-related arts, each component (e.g., a module or engine) illustrated in FIG. 3 may represent a set of logic (e.g., executable software instructions) and the corresponding hardware (e.g., memory and processor) for executing the set of logic. Further, each component illustrated in FIG. 3 may be hosted on dedicated or shared server machines that are communicatively coupled to enable communications between server machines. Further, each component illustrated in FIG. 3 may be integrated into web client 110 (e.g., direct integration), web-service application 124 (e.g., for remote processing), or other applications of network system 100.

The web client 110 is illustrated in FIG. 3 as including a transmission module 300, a primary application module 302, an interface module 304, a context analysis module 306, a context option module 308, and a context query modification module 310, all configured to communicate with each other (e.g., via a bus, shared memory, a switch, or application programming interface (APIs)). Each of the various components of the web client 110 may be in communication with one or more third party applications 128. Further, while the components depicted in FIG. 3 are discussed in the singular sense, it will be appreciated that in other embodiments multiple instances of any one of these components may be deployed.

The transmission module 300 is responsible for interfacing the web client 110 with the network 102 and network entities, such as third party server 108, web server 116, or API server 114. For instance, when client device 106 receives an initial query through the contact interface, the initial query may be transmitted to application server 118 through transmission module 300. The primary application module 302 may be web-browser operable to provide an application as a web-service. In some embodiments, primary application module 302 is a mobile application (e.g., “app”) configured for a special purpose, such as connecting to a network-based publishing system 104 to provide access to the web-service application 124. The primary application module 302 may be initialized from an icon selectable from the screen of the client device 106. In those embodiments where the primary application module 302 is configured for a special purpose, primary application module 302 may have preloaded network addresses which may be used to address queries or search strings to web-service application 124 or other computing entities in the network-based publishing system 104.

The interface module 304 is responsible for detecting user actions on the contact display. The user actions may include one or more of: a non-force touch selection (e.g., a tap), a time-based force-interval selection (e.g., press-and-hold), an acceleration or pressure-based force-interval selection (e.g., firmly pressing on an area of the contact display), and other types of user actions, such as holding down a mechanical button on the client device 106 while selecting one or more display element on the contact display. The interface module 304 may be configured to identify the one or more elements selected on the screen in response to detecting a user action, such as a force-interval selection. The interface module 304 may convey the identity of the one or more of the selected display elements to the context analysis module 306.

The context analysis module 306 determines the context of the one or more selected display elements. In some embodiments, the context analysis module 306 determines context by identifying what type of display element is selected. For example, the context analysis module 306 may identify the selected elements as descriptive text that describes one or more attributes of the listed item. In some embodiments, the context analysis module 306 may identify the selected elements as relating to one or more transaction parameters. For example, the context analysis module 306 may determine that the price of a listed item has been selected, or that a shipping field has been selected (e.g., selecting free shipping). In at least one embodiment, the context analysis module 306 comprises a rule base that can be configured by the application developer with one or more rules to guide identification of the selected display element. For example, one rule may comprise the following logic: if one or more words in the description are selected, the selected display elements are keywords. Another rule may include: if a number is selected, identify abbreviations nearby the number to identify the units; further, if a money sign is near the number (e.g., $), then the number is the price of the listed item; further, if other units are nearby (e.g., 100 GB), the number describes an attribute of the listed item.

In some embodiments, the context analysis module 306 may identify the type of selected element based on what type of field comprises the selected data. For example, if the word “free shipping” is selected, it is determined that the display element is from the shipping field of the web page. In contrast, if the display element selected is from the title, it is a keyword. In some embodiments, the mark-up language or tags of the underlying web page are analyzed to determine the type of display element. For instance, the web page (or application page) showing the items listings may have underlying tags (e.g., XML tags) that identify context enclosed by the tags.

Further, in some embodiments, semantics analysis may be performed to determine how the selected display element relates to its corresponding listing. For example, if the word “pink” is selected, the content analysis module 306 may determine that pink is a type of color, but also may be the name of a music artist. In those cases, other terms in the search string can be consulted: if the search string is “pink shoes”, then the context analysis module 306 may determine that “pink” is an attribute of the searched for item, shoes. In those cases, the category searched in or requested, if any, by the search string may be consulted to perform further analysis. For example, if the term “pink” is the selected display element, the context analysis module 306 may first identify that “music” was selected as a search category, then determine that the subject of the search is the music artist “Pink”, not a color.

The context option module 308 can receive identification of the selected display elements, determine context options based on what type of display elements have been selected, display the options, and receive selection of one of the options from a user through the context interface, as according to some embodiments. The context options are options of what actions can be performed to refine the query or search string. For example, if a price is selected, the available options may be “search for lower prices” (e.g., search for the same item or search string, but only return results that have a lower price than the selected price). Similarly, if a keyword is selected, an option may include “append and research”.

Using the above example, if it is determined that the word “pink” is selected and is an attribute of the item (e.g., pink shoes), the correlated option for display can be “create pink color filter” (e.g., return results for shoes, where a color filter has been set to “only pink”). Whereas, for example, if it is determined that “pink” is selected and the search is within a “music” category, an option may include “Append [latest album]”, where the latest album of the music artist may be appended to the search string. Further, in some embodiments where no category has been set, a context option may include “Search Pink in Music Category”, which can refine results by selecting an item category, thereby excluding irrelevant results (e.g., pink shoes).

In at least one embodiment, the context option module 308 may have a data store that correlates types of selected display elements to available options. Further, the context option module 308 may be configured to receive selection of the one or more displayed options from the user acting through the contact interface and interface module 304.

The context query modification module 310 modifies or generates a new query based on which context option is selected. For example, if an append option is selected, the context query modification module 310 may generate a new search string with the selected keyword appended to the end of the search string. Further, as an example, if a filter is created (e.g., pink color filter), a new context modified query may be generated that comprises the original search string with filter metadata that limits the query results per the filter. Once a context modified query is generated, the context query modification module 310 may be configured to automatically transmit (e.g., via the transmission module 300) the modified query to the web-service application 124 for further refined search results.

Though the above modules are discussed individually as separate units, it is appreciated that aspects or functions of each module can be combined into a single module. For example, in at least one example embodiment, the context analysis module 306, the context option module 308, and the context query modification module 310 may be integrated into a single module, which can receive selected display elements as input and generate context modified queries as output.

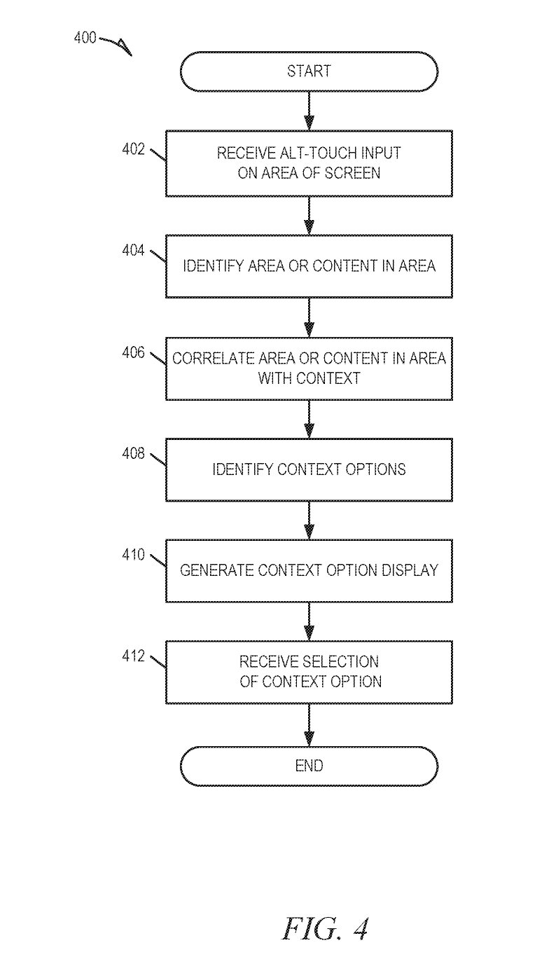

FIG. 4 shows a flowchart illustrating a method 400 for processing context modified queries, as according to some embodiments. The method 400 may be performed by one or more modules of FIG. 3. The method 400 may be embodied in computer-readable instructions for execution by one or more processors such that the steps of the method 400 may be performed in part or in whole by the client device 106; while in some embodiments, some steps of method 400 may be transmitted from client device 106 to application server 118 for further processing. For example, a context analysis or identification of context of a selected display element may be transmitted to application server 118 for remote processing. Accordingly, the method 400 is described below by way of example with reference thereto. However, it shall be appreciated that the method 400 may be deployed on various other hardware configurations and is not intended to be limited to the functional components of the context query modification application 112A.

Prior to the operations shown in method 400, a client device (e.g., the client device 106) may have received a search string, received search string results, and displayed the search string results as a web page or page of an application on a contact display of the client device 106.

At operation 402, the client device 106 receives a force-interval selection of one or more display elements displayed on the contact display of the client device 106. The client device 106 can use the interface module 304 to distinguish between regular user actions, such as a screen tap selection, or a force-interval selection. The contact display may, in some embodiments, be a touch-screen device display of a mobile phone, tablet, laptop or desktop computer. The interface module 304 in the client device 106 may determine that selection of the display elements is a force-interval selection rather than, for example, a tap. As discussed above, the force-interval selection can be a time-based selection action, such as pressing down on an area to be selected and holding for a period of time (e.g., press-and-hold selection), or the force-interval selection can be a pressure-based selection action, such as pressing down more firmly to select an item (e.g., more firm or at a greater pressure than common tap pressure). In some embodiments, the force-interval selection may be resting a finger on a display item, followed by a more firm depression of the screen. The interface module 304 can be configured to detect the first action, a tap, followed by a firm press without lifting the finger, to be a force-selection action.

At operation 404, the context analysis module 306 identifies the area in the display screen from which the display elements were selected. For example, the context analysis module 306 may determine that the selected display items were display items in a description area of the display screen, title area of the display screen, image area of the display screen, or other fields preconfigured to hold items or transaction descriptions (e.g., a shipping field, a tax field, an item lister username field, country/geographic distance field(s)). Further, in some embodiments, the context analysis module 306 may identify the area or content in a selected area by identifying which underlying mark-up language tags enclose the selected display elements. For example, a price element may be enclosed with mark-up tags that are configured for the web client 110, e.g., <price> . . . </price>, which can be used to determine that the selected display element is the price of an item in the query results.

In some embodiments, the area or content in the area of the selected display elements may be determined through tag parameters in the mark-up language. For example, where a general description tag (e.g., <description>) is used for a listed item, the tag parameters may describe the content of different lines of code within a general description section, e.g., <description field=price> . . . </description>, where “field” is a tag parameter with the value of “price”. In this way, different types of display elements within a general description area can be managed and tracked.

At operation 406, context analysis module 306 may correlate the identified area or content in an area with a context, such as item description (e.g., model, color) or transaction description (e.g., price, shipping cost, country of origin). In some embodiments, the context analysis module 306 may offload context identification by transmitting which display elements have been selected to the web-service application 124 for more in-depth processing. Generally, context for a selected element corresponds to the elements surroundings or purpose within a display page. For example, field parameters, such as shipping and price, correspond to a transaction context. As another example, keywords can correspond to a context of item description or class attributes (e.g., color, model, features, and technical specifications) of the item. As another example, the area from which an element may is selected may determine context (e.g., an item selected from a <body></body> area of a page may correspond to item description context). As another example, the type of object selected may be used to identify context (e.g., if a element with a “.png” suffix is selected, the context may correspond to images, and the user may want to perform an image search, or find similar images).

At operation 408, the context option module 308 may determine one or more context options based on the context of the identified display elements. The context option module 308 may determine which context options are available per context by consulting a look-up in a data store that is local to the client device 106. For example, if “free shipping” is selected, the selected term may be identified as having a transaction context at operation 406; then at operation 408, a lookup may be performed by accessing database 122 to determine that the available context options include: generate new search for the same subject matter but include a field parameter filter so only results are returned that have “free shipping”.

In some embodiments, the context option module 308 may determine which context options are available using a remote service for in-depth analysis. For example, once the selection of display elements is received, the context option module 308 may transmit the selection of display elements to the web-service application 124 for further processing. The web-service application 124 is run from application server 118, which is a more robust computer than client device 106 (e.g., more computational power, more memory, more analysis programs). Further, application server 118 can consult with database 122 and or other services (e.g., third party server 108) to more thoroughly determine context and context options.

At operation 410, the context option module 308 may generate a display of available options on the contact display of the client device 106. In some embodiments, the context option module 308 may display the context option using interface elements entirely run within web client 110. For example, the context options may be displayed as linked text or pop-up menus generated within web client 110, without requiring any calls being made to the client device operating system. In some embodiments, the context options may be displayed by making a call to the client device operating system to generate a native menu that is run in a similar manner across different applications by the operating system of the client device 106. The native menu has a look-and-feel that is configured by the operating system and can keep the user interaction with the context query modification application 112A familiar and consistent.

At operation 412, the client device 106 receives a selection of a displayed context option through the contact interface of the client device 106. After operation 412, the method 400 may terminate and transmit values, such as which context option was selected, to the context query modification module 310; which can perform further operations as discussed by operations 220-230 in FIG. 2B.

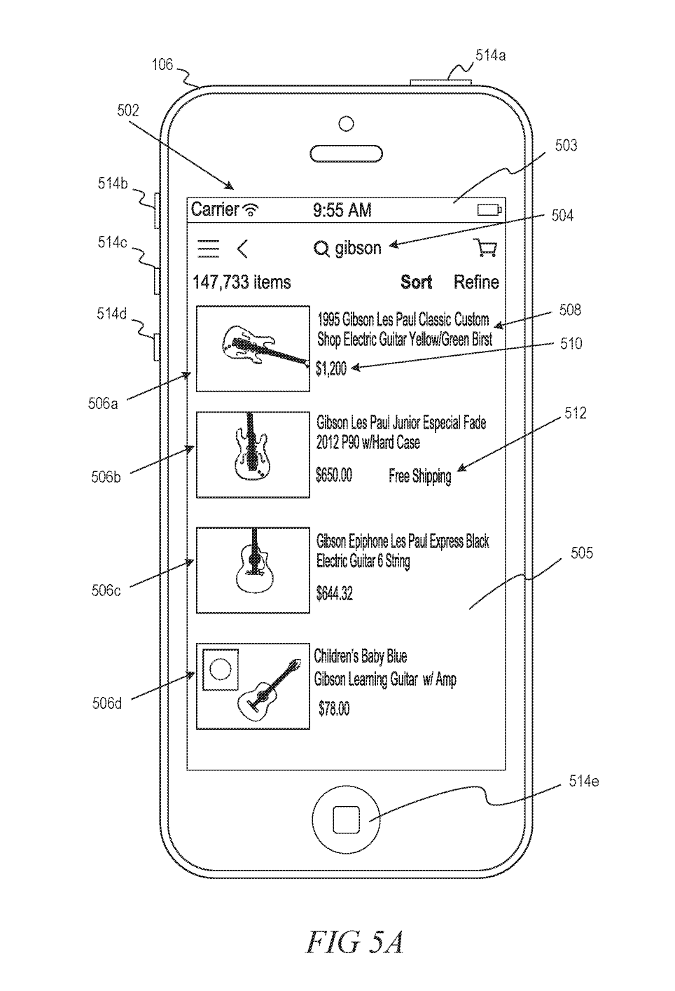

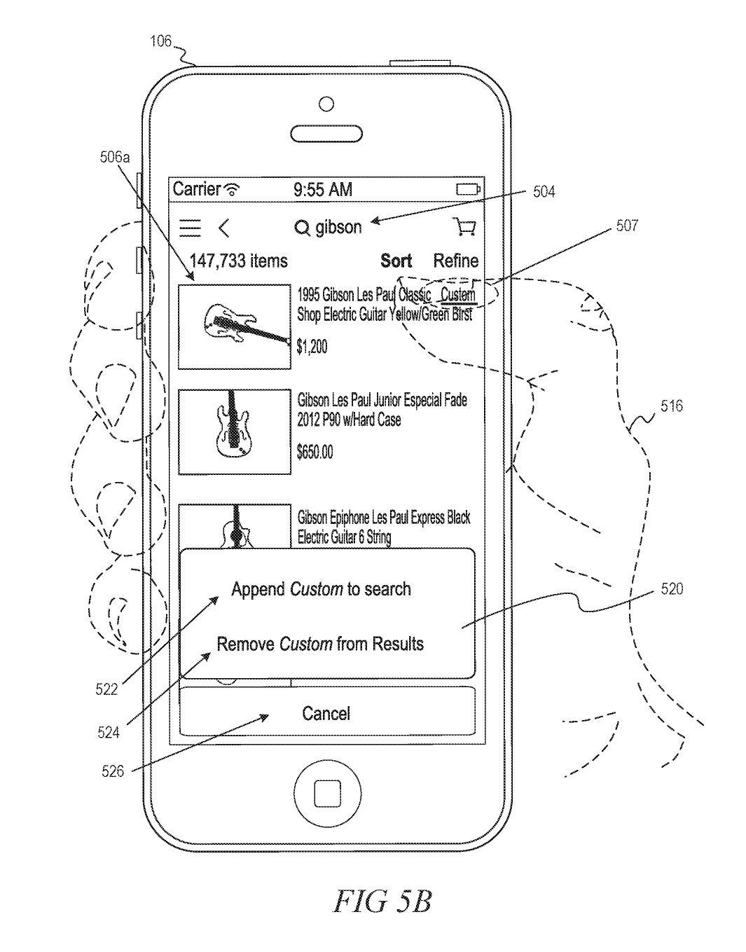

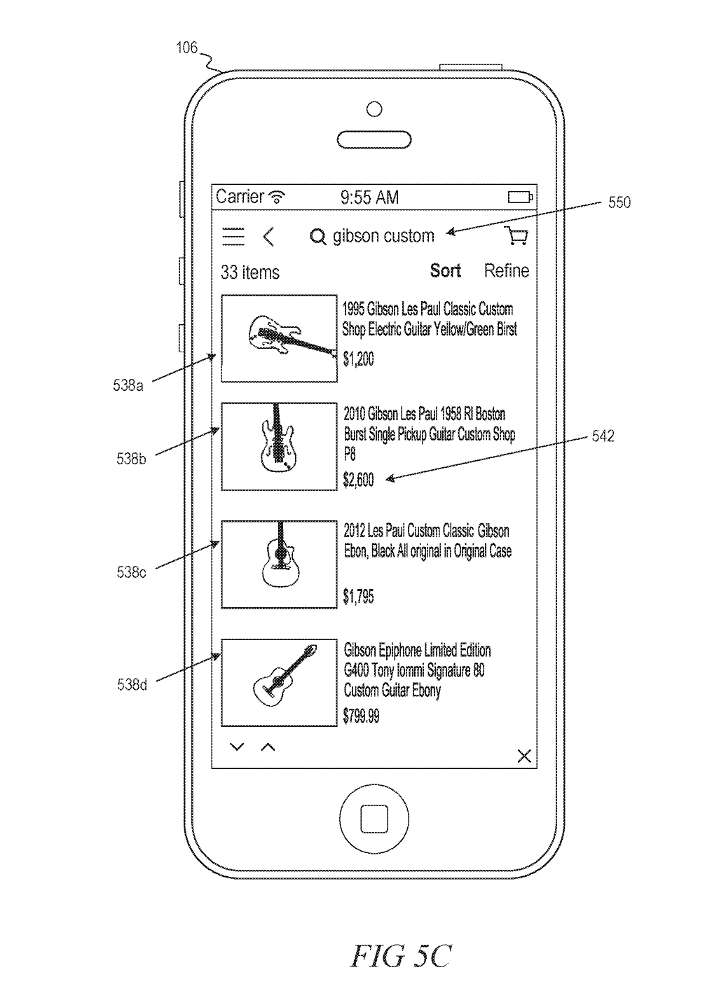

FIGS. 5A-5C illustrate a client device 500 and user interfaces for context modification of queries, as according to some embodiments. Client device 500 can correspond to the client device 106 of FIG. 1. In one embodiment, client device 500 comprises the modules of FIG. 3, which can be stored on and executed from non-transitory memory of the client device 500. The modules may be executed by one or more processors of the client device 500 to perform any of the methods, operations, and interactions, disclosed herein, as discussed above.

FIG. 5A illustrates an example of the client device 106 implemented as a mobile computer or cellular phone having a contact display interface 502, which displays a user interface. The contact display interface 502 can be implemented as touch-screen display, on which a user of the client device 106 can select elements displayed on-screen through direct contact with the contact display interface 502. In at least one embodiment, the contact display interface 502 interfaces with an interface module, such as the interface module 304, to distinguish between tap clicks, double clicks, and force-interval selections. In some embodiments, the operating system of the client device 106 comprises the interface module 304 (e.g., executable from non-transitory memory of client device 106) that manages the identification of what kind of user interaction is being received (e.g., tap clicks, double clicks, and force-interval selections). For example, an operating system interface module may identify a force click selection and forward the force-interval selection data to an application running on the client device 106 for further processing.

In some embodiments, feedback is provided to the contact display interface 502 to notify the user making a selection that a force-interval selection has been triggered. For example, a user may press-and-hold over a display element for 500 milliseconds, after which haptic feedback (e.g., vibration) is provided to the user through the contact display interface 502 to let the user know he/she has selected the display element with a force touch action. The client device 106 includes one or more transducers, such as mechanical or electro-mechanical buttons 514a-e. As discussed, in at least one embodiment, a user can perform an alternative click instead of a force-interval selection to trigger a context query modification process. For example, the user may press and hold home button 514e while tapping on a display element of the contact display interface 502 to trigger a context query modification for the tapped-on display element.

The user interface illustrated within the contact display interface 502 may display elements generated by the operating system of client device 106, such as the status bar 503. Further, the user interface may also display elements generated by an application run by the client device 106. For example, as illustrated, display elements for an item listing application 505 can be displayed in a main area of the display interface 502. Item listing application 505 may correspond to the web client 110 of FIG. 1 and can implement one or more of the modules of FIG. 3.

In the illustrated example of FIG. 5A, the display elements of item listing application 505 include a search area 504 having a search string of “gibson”, which the user may have entered using a pop-up on-screen keyboard (not depicted). The client device 500 may receive the search string “gibson” and retrieve results from the application server 118 and web-service application 124 for item listings matching the search string “gibson”. FIG. 5A shows example returned results as display elements 506a-d, which show several Gibson guitars with display elements describing attributes 508 of the items, e.g., color, string number, as well as display elements describing transaction parameters, such as a price 510 and shipping 512.

FIG. 5B illustrates a user interacting with the client device 500 to perform a context query modification, as according to some embodiments. As illustrated, a user may use his/her thumb 516 to select a display element, such as the “custom” in the description area of item display element 506a. In some embodiments, the user uses his/her thumb 516 to perform a force-interval selection of the term “custom”, as highlighted by action circle 507. Next, an interface module, such as interface module 304 or a native interface module, detects the force-interval selection of the term “custom”, determines the context, and identifies context options, as described above.

The context options may be displayed in a menu 520, which displays “Append Custom to Search” as a first context option 522, and “Remove Custom from Results” as a second context option 524. An append context option may append the selected display element term to the end of the search string for a new search. A remove context option can create a negative filter that removes all results that contain the selected word. Further, as illustrated, menu 520 includes a “Cancel” option 526, which removes the menu 520 and terminates the context query modification process.

The menu 520 may be generated as a native menu generated by the operating system of the client device 500. For example, the item listing application 505 may receive input of which display elements were force-interval selected, determine context, determine context options, then convey the context options to the operating system for display through a native menu. Further, in some embodiments, the menu 520 may be generated as one or more display elements within the item listing application 505. For example, the menu 520 may be a new layer that is generated within item listing application 505 and then overlaid as a new layer over the results and underlying content (e.g., search results).

In some embodiments, the menu 520 may be generated as a pop-up that emanates from or around the selected display element. For example, the menu 520 may be generated as a pop-up menu near action circle 507. In this way, the user can use his/her thumb 516 to more readily access the menu 520 because his/her thumb 516 is likely in the area around action circle 507 because selection of “custom” just occurred.

In some embodiments, the menu 520 may be displayed as one or more integrated display elements (e.g., html objects in the underlying content), instead of being displayed as an overlay. In those embodiments, a new page may be generated by item listing application 505 that comprises the display elements 506a-d alongside the first context option 522 and second context option 524 in the same layer. The resulting page may be longer height-wise, but scrollable or otherwise navigable to view all the display elements 506a-d.

Assuming the user has selected the first context option 522. “Append Custom to Search”, the item listing application 505 may append the term “custom” to “gibson” to create a context modified query of “gibson custom”. The context modified query “gibson custom” may then be transmitted to the web-service application 124 to retrieve results from the database 122.

FIG. 5C illustrates example item results 538a-d for the context modified query of “gibson custom”. As illustrated, the item results 538a-d have been refined to only include item results that have “gibson” and “custom” in their respective descriptions; that is, item results 538a-d show results for custom Gibson guitars. To further refine the results, as a further example, the user may select (e.g., force-interval select) another display element, such as price display element 542, to create a new context modified query that includes only results that are higher than $2600 or lower than $2600. In this way, by selecting display elements from anywhere on the contact display interface 502, a user can more efficiently refine search results of searched for items.

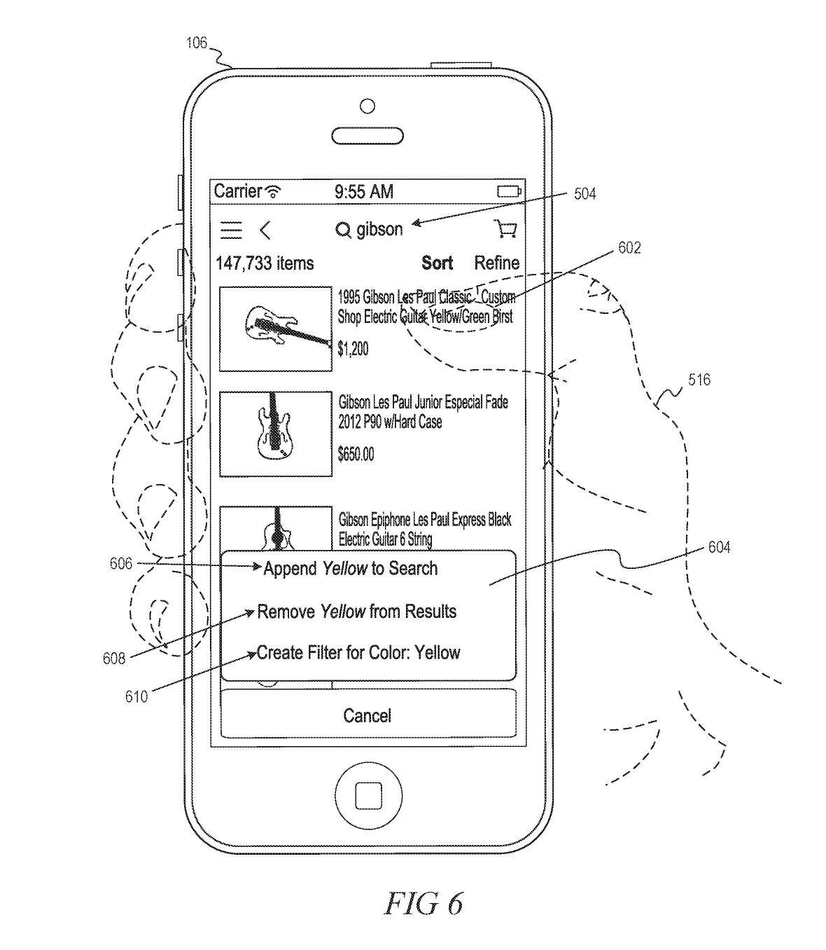

FIG. 6 shows an example in which a different display element is selected and different context options are displayed, as according to some embodiments. As illustrated in FIG. 6, the user has used his/her thumb 516 to force-interval select the display element “yellow”, as highlighted by action circle 602. Responsive to the selection, a menu 604 is generated which displays “Append Yellow to Search”, as a first context option 606; “Remove Yellow from Results”, as a second context option 608; and “Create Filter for Color: Yellow”, as a third context option 610.

In the example shown in FIG. 6, the item listing application 505 may use the approaches described above to identify and provide additional context options. In particular, with reference to FIGS. 5A-5C, the term “custom” may be identified as an appendable term but also identified as not being associated with any category filter. As such, only the first context option 522 and second context option 524 are displayed, neither of which are categorical filters.

In contrast, with reference to FIG. 6, the term “yellow” may be identified as being appendable and being related to a categorical filter because the selected element yellow is a attribute of the returned class of items (e.g., a class attribute). Thus, as illustrated in FIG. 6, the third context option 610 is displayed. When third context option 610 is selected by the user, the original search string “gibson” is modified with filter metadata and stored or transmitted to the application server 118 for new query results. The returned results may be for items that match “gibson” and are yellow in color, for example.

Thus what has been disclosed is an approach for context modification of queries to improve or refine search results. A user may make a force-interval selection of one or more display elements displayed on the screen of a mobile computing device. The selected display elements may be analyzed to determine their context. One or more context options may be displayed onscreen for user selection. A selected context option can cause the mobile computing device to modify the original query to generate a context-modified query. The context-modified query can be used to retrieve refined search results. In this way, the user avoids multiple menus and continuously using a keyboard to manually modify search strings or queries.

### Machine Architecture

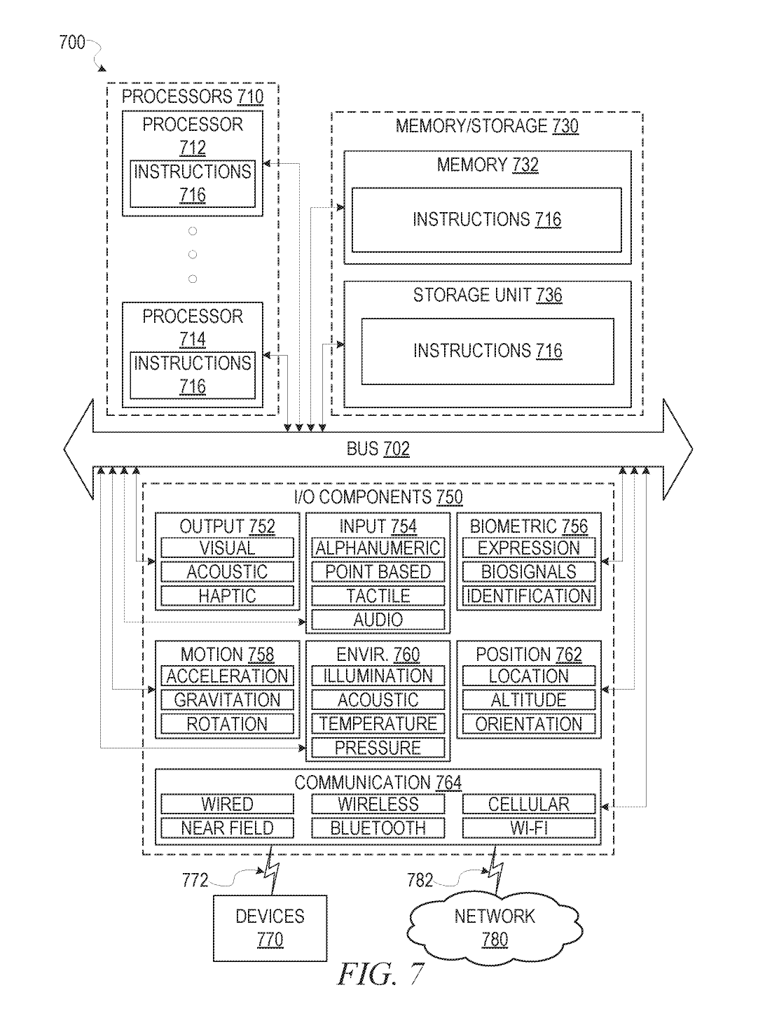

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example, the instructions 716 may include executable code that causes the machine 700 to execute the context query modification application 112A and the associated functionalities described herein. These instructions 716 transform the general, non-programmed machine 700 into a particular machine 700 programmed to carry out the described and illustrated functions of the context query modification application 112A in the manner described herein. The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. By way of non-limiting example, the machine 700 may comprise or correspond to a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory/storage 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 712 and a processor 714 that may execute the instructions 716. The term “processor” is intended to include a multi-core processor that may comprise two or more independent processors (sometimes referred to as “cores”) that may execute instructions contemporaneously. Although FIG. 7 shows multiple processors 710, the machine 700 may include a single processor with a single core, a single processor with multiple cores (e.g., a multi-core processor), multiple processors with a single core, multiple processors with multiples cores, or any combination thereof.

The memory/storage 730 may include a memory 732, such as a main memory, or other memory storage, and a storage unit 736, both accessible to the processors 710 such as via the bus 702. The storage unit 736 and memory 732 store the instructions 716 embodying any one or more of the methodologies or functions described herein. The instructions 716 may also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of the processors 710 are examples of machine-readable media.

As used herein, “machine-readable medium” means a device able to store instructions and data temporarily or permanently, and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine (e.g., processors 710), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), acoustic sensor components (e.g., one or more microphones that detect background noise), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772 respectively. For example, the communication components 764 may include a network interface component or other suitable device to interface with the network 780. In further examples, the communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a Universal Serial Bus (USB)).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code. Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology. Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA). Worldwide Interoperability for Microwave Access (WiMAX), Long Term Evolution (LTE) standard, others defined by various standard-setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 716 may be transmitted or received using a transmission medium via the coupling 772 (e.g., a peer-to-peer coupling) to the devices 770. The term “transmission medium” shall be taken to include any intangible medium that is capable of storing, encoding, or carrying the instructions 716 for execution by the machine 700, and includes digital or analog communications signals or other intangible media to facilitate communication of such software.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network 102.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice.

### Language

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

What is claimed is:

1. A computer-implemented method for modifying application queries, comprising:
displaying initial query results for an initial query received from a contact display interface;
receiving, via the contact display interface, a force-interval selection of a display element of the initial query results;
determining a context of the display element;
modifying the initial query based at least in part on the context of the display element to generate a modified query; and
receiving modified query results for display on the contact display interface.

2. The computer-implemented method of claim 1, further comprising:
displaying one or more options for modifying the initial query based on the context; and
receiving selection of the one or more options through the contact display interface.

3. The computer-implemented method of claim 2, wherein the initial query results are modified based on the selection.

4. The computer-implemented method of claim 1, wherein the context is determined based on the selected display elements comprising keywords from a description area for an item in the initial query results.

5. The computer-implemented method of claim 1, wherein the context is determined based on a location of the selected display element within the contact display interface, the location of the selected display element corresponding to a field parameter or tag that indicates context.

6. The computer-implemented method of claim 1, wherein the context is determined based on a class attribute of the selected display element.

7. The computer-implemented method of claim 1, wherein the force-interval selection is a selection action based on an amount of time in contact with the contact display interface in selecting the display element.

8. The computer-implemented method of claim 1, wherein the force-interval selection is a selection action based on an amount of pressure applied to the contact display interface in selecting the display element.

9. The computer-implemented method of claim 1, wherein the contact display interface is a touch-screen display of a mobile device, and the initial query results and modified query results are received from a server over a network.

10. A system for modifying application queries, the system comprising:
one or more processors of a machine; and
a memory storing instructions that, when executed by the one or more processors, cause the machine to:
display initial query results for an initial query received from a contact display interface;
receive, via the contact display interface, a force-interval selection of a display element of the initial query results;
determine a context of the display element;
modify the initial query based at least in part on the context of the display element to generate a modified query; and
receive modified query results for display on the contact display interface.

11. The system of claim 10, wherein the instructions further cause the machine to:
display one or more options for modifying the initial query based on the context; and
receive selection of the one or more options through the contact display interface.

12. The system of claim 11, wherein the initial query results are modified based on the selection.

13. The system of claim 10, wherein the context is determined based on the selected display elements comprising keywords from a description area for an item in the initial query results.

14. The system of claim 10, wherein the context is determined based on a location of the selected display element within the contact display interface, the location of the selected display element corresponding to a field parameter or tag that indicates context.

15. The system of claim 10, wherein the context is determined based on a class attribute of the selected display element.

16. The system of claim 10, wherein the force-interval selection is a selection action based on an amount of time in contact with the contact display interface in selecting the display element.

17. The system of claim 10, wherein the force-interval selection is a selection action based on an amount of pressure applied to the contact display interface in selecting the display element.

18. The system of claim 10, wherein the contact display interface is a touch-screen display of a mobile device, and the initial query results and modified query results are received from a server over a network.

19. A non-transitory machine-readable storage medium embodying instructions that, when executed by a machine, cause the machine to perform operations comprising:
display initial query results for an initial query received from a contact display interface;
receive, via the contact display interface, a force-interval selection of a display element of the initial query results;
determine a context of the display element;
modify the initial query based at least in part on the context of the display element to generate a modified query; and
receive modified query results for display on the contact display interface.

20. The computer-readable storage medium of claim 19, wherein the instructions further cause the machine to perform operations comprising:
display one or more options for modifying the initial query based on the context;
receive selection of the one or more options through the contact display interface; and
generating a modified query result by modifying the initial query based on the selection of the one or more options.
